(19) United States
(12) Patent Application Publication
(10) Pub. No.: US 2023/0246452 A1
(43) Pub. Date: Aug. 3, 2023

(54) POWER RECOVERY UNDER GRID CONTINGENCIES USING DROOP-CONTROLLED GRID-FORMING INVERTERS

(71) Applicant: Regents of the University of Minnesota, Minneapolis, MN (US)

(72) Inventors: Soham Chakraborty, Minneapolis, MN (US); Sourav Patel, Minneapolis, MN (US); Murti V. Salapaka, Plymouth, MN (US)

(21) Appl. No.: 18/103,090

(22) Filed: Jan. 30, 2023

Related U.S. Application Data
(60) Provisional application No. 63/304,546, filed on Jan. 28, 2022.
(60) Provisional application No. 63/441,337, filed on Jan. 26, 2023.

(51) Int. Cl. H02J 3/40; H02J 9/06

(52) U.S. Cl. CPC H02J 3/40; H02J 9/062

(57) ABSTRACT

A method and system of maintaining electrical power to one or more designated loads connected to an electrical bus that is selectively connected to an electric power grid as a first source of power and to an inverter for providing power to the bus from a second source of electrical power. A controller receives an input indicating if the bus is connected to the grid. The inverter is operated to be synchronized with the grid and provide a selected amount of active and reactive electrical power from the second source of electrical power while the one or more designated loads receive electrical power from the grid. Connection of the bus to the grid is monitored and at the time the electrical bus is no longer receiving power from the grid, the inverter is operated to provide required power without interruption to the one or more designated loads of the bus.

### CROSS-REFERENCE TO RELATED APPLICATIONS

This application claims the benefit of U.S. Provisional Patent Application Ser. No. 63/304,546, filed Jan. 28, 2022 and U.S. Provisional Patent Application Ser. No. 63/441,337, filed Jan. 26, 2023, the contents of which are incorporated herein by reference in their entirety.

### GOVERNMENT INTEREST

This invention was made with Government support under contract number DE-AR0001016 awarded by DOE, Office of ARPA-E. The Government has certain rights in this invention. The government has certain interests in the invention.

### BACKGROUND

The discussion below is merely provided for general background information and is not intended to be used as an aid in determining the scope of the claimed subject matter.

Critical infrastructure (CI) describes essential assets of society that include but are not limited to medical centers and hospitals, security service centers and communication infrastructures. Disruption of power to CIs often result in a debilitating impact on physical and economic security, public health and safety. Rapid and seamless recovery of power, possibly after a power blackout caused by weather/climate disasters, to restore CIs online is a crucial need arising in scenarios that are increasingly becoming more frequent. IEEE 602 recommends CIs to include emergency power supply systems (EPSS) in order to form a local microgrid network with local generation sets and automatic transfer switches (ATSs), in case of sudden power blackouts. Depending on the level of criticality and urgency of electrical loads, the EPSS is required to be activated within a specified time in order to restore the operation of CIs. Various types of EPSS include, Type-U that designate uninterruptible EPSS and Type-10 that allows 10s for recovery. Gas/diesel generator sets are traditional choices for most EPSS due to their sustained and robust power supply capability. However, the long startup time of such assets from standby mode makes the task of seamless power restoration difficult to achieve.

Battery storage units interfaced with power inverters provide an alternate solution that enhances the ease in operation and reduces the response time of EPSS for CIs. NFPA 111 recommend stored-energy EPSS (SEPSS) that employ batteries/fuel-cells/ultra-capacitors as main energy harvesting units along with voltage source inverter (VSI) topology to assist in restoration of power to CIs in case of grid failure. To achieve seamless recovery of power for Type-U SEPSS that demand no electrical interruption, VSIs are required to be synchronized and connected all the time with the network of the CI irrespective of the availability of main grid, unlike plug-and-play strategies. However, remaining synchronized and being active with the network pose significant challenges to the operation of VSIs and to the normal operation of CIs. Here SEPSS, while ensuring that the VSIs are connected to the system, needs to guarantee that the VSIs' do not alter the normal operation of the CI and should supply no power when the grid is available. Thus in on-grid mode, all of the power to the CI is to be supplied only by the grid, with the VSIs remaining on standby to enable a seamless transition to off-grid mode in case of grid interruption. In case of grid failure, SEPSS is required to ensure that the CI can function while maintaining a stable voltage and frequency and meeting the power demand by the locally stored energy units via VSIs in off-grid mode. While on-grid it is crucial for SEPSS to maintain sufficient reserves of energy in battery storage units for emergency off-grid operation and for seamless transitions to an off-grid operation, the VSIs need to operate on a grid-forming mode even when connected to the grid.

Droop controller-based autonomous and communication-less approach for paralleling multiple battery-fed grid-forming (GFM) VSIs in off-grid mode is an effective decentralized strategy. It is known, conventional droop control can be used for multiple inverters in dominantly inductive microgrid network by emulating the behavior of synchronous generators in traditional power systems. For other network conditions that arise in power distribution systems, several modifications on droop control have been proposed that emphasize improved power sharing capabilities. However, all these techniques are primarily restricted to microgrids operating in off-grid mode only. During the on-grid mode, the voltage and frequency of the network are governed by the stiff grid and as a result, unlike the off-grid operation, the control over output active and reactive power of the droop-controlled GFM VSIs is challenging as it is heavily influenced by the distribution grid. In addition, a seamless transition between on-grid and off-grid mode, and stable operation during and after these transitions of microgrid are also challenging tasks.

On-grid mode of operation and smoothness of mode transition rely heavily on VSI control schemes, which remains challenging. A hierarchical control architecture has been proposed where the active and reactive power references of VSIs are adjusted dynamically using secondary layer control during on-grid mode. However, this architecture is challenging to implement because of the added communication and control layers on top of the primary control layers of microgrid. In a further technique, adaptive droop control for VSIs suitable for both on- and off-grid mode of operation of microgrid has also been proposed. However, knowledge of magnitude, type of grid impedance and coupling impedances of VSIs are prerequisite for this control which may not be practical in distribution systems where the values keep changing. Master-slave-based architecture in multi-VSI systems (electrically closest VSI to grid as master and rest of the VSIs as slaves) has also been proposed both for on- and off-grid mode. However, a coordinated architecture is required which suffers from the loss of autonomy and independent nature of operation of multi-VSIs. In yet a further technique, the droop control law for VSIs is modified to achieve operation in on-grid mode. In this technique, the prime focus is to inherit the advantages of the droop controller to limit the inverter current under both normal and faulty conditions. Dual mode operation capability (i.e. grid-following operation in on-grid and grid-forming operation in off-grid mode) employed to VSIs is an usual solution to avail seamless transition capability. Prior state-of-the-art on dual-mode control architecture provide methods to minimize fluctuations in phase, frequency, and voltage amplitude of the network during the transitions. However, large deviations in the output voltage/current of VSI due to switching of its operating mode are drawbacks that restrict a smooth transition for microgrid and severely affects microgrid stability. Traditional inverter control with an additional layer to generate reference signals has also been proposed, enabling seamless mode transition for VSIs. However, the additional control layer and its parameter tuning for restoring voltage deviations and synchronize phase to grid before connection/reconnection makes the solution difficult to realize in practical control boards. A distributed mode-supervisory control between multiple VSIs and the grid has also been proposed to avail both on- and off-grid operation and seamless transition capability. Even though the distributed architecture reduces communication burden, multiple-point failure and undesired delays in communication makes the solution vulnerable in this application.

### SUMMARY

This Summary and the Abstract herein are provided to introduce a selection of concepts in a simplified form that are further described below in the Detailed Description. This Summary and the Abstract are not intended to identify key features or essential features of the claimed subject matter, nor are they intended to be used as an aid in determining the scope of the claimed subject matter. The claimed subject matter is not limited to implementations that solve any or all disadvantages noted in the Background.

It is observed that there is a lack of unified and single control architecture that enables inverter to; 1) operate in on-grid mode with strict regulation of output active and reactive power, 2) operate autonomously in off-grid mode, and 3) exhibit seamless transition capability. Aiming to achieve these functionalities with reduced communication burden and ease in implementability in practice, a novel mode-dependent droop control framework is disclosed that enables VSIs to operate in grid-forming mode all the time, unlike the traditional prior solutions.

A method and system of maintaining electrical power to one or more designated loads connected to an electrical bus that is selectively connected to an electric power grid as a first source of power and to an inverter for providing power to the bus from a second source of electrical power. A controller receives an input indicating if the bus is connected to the grid. The inverter is operated to be synchronized with the grid and provide a selected amount of active and reactive electrical power from the second source of electrical power while the one or more designated loads receive electrical power from the grid. Connection of the bus to the grid is monitored and at the time the electrical bus is no longer receiving power from the grid, the inverter is operated to provide required power without interruption to the one or more designated loads of the bus.

In another aspect, the invention comprises an apparatus having an inverter and a controller, the controller configured to control the inverter based on the method above.

The control framework regulates output active and reactive power of the VSIs to the desired value. Typically, the desired value is zero while operating in on-grid mode; however, although advantageous, this should not be considered limiting in that, if desired, there may be situations where some power is sourced through the VSIs in on-grid mode. The control technique disclosed provides a fast response time of recovery once the main grid fails by VSIs operating in grid-forming mode all the time for seamless transition irrespective of whether the grid is there or not. The control technique disclosed uses minimal information of grid/network status for the mode transition of droop control. Essentially, all that is needed is a status variable indicative of grid availability, i.e. whether the grid is available or not. In one embodiment, the status of grid availability can be represented by a single bit (0 or 1) representing grid availability. Grid availability can be detected using any number of techniques. For instance, standard island detection techniques such as the remote island detection techniques can be used. In one embodiment, supervisory remote island detection can be used because of its fast and accurate performance. Moreover, a non-PLL-based grid re-synchronization process can be used for the grid re-connection process. In yet another embodiment, the status or operation of the feeder switch or breaker connecting the CIs to the grid can be monitored, or the control signal to the feeder switch can be provided directly or indirectly to the proposed control circuitry.

The inverters of the disclosed invention will remain synchronized to the grid and can be regulated to supply no active and reactive power, if desired, to the grid while operating in on-grid mode with the entire load of CI supplied by the grid. Whereas, during off-grid mode the VSIs share the required critical load demand among themselves (when multiple VSIs are present which is common although in some situations not required) while exhibiting a seamless transition from on-grid mode after grid failure to act as primary source of generations for the CI.

### BRIEF DESCRIPTION OF THE DRAWINGS

FIG. 1 is a schematic diagram of a simplified operating environment.

FIG. 2 is a schematic of an exemplary VSI power circuit.

FIG. 3 is a schematic diagram of a mode-dependent droop controller.

FIG. 4 is a schematic diagram of an inner-current-outer-voltage controller.

### DETAILED DESCRIPTION OF THE ILLUSTRATIVE EMBODIMENT

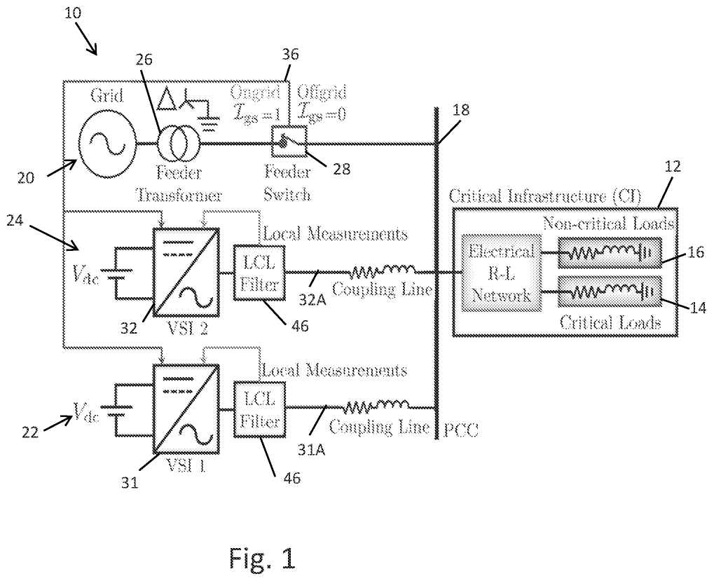

A schematic diagram of a simplified operating environment or networked system 10 is illustrated in FIG. 1. A critical infrastructure CI is illustrated at 12, and in the illustrative embodiment has two classification of loads (herein as defined in NFPA 111) namely, critical loads 14 that need continuous uninterrupted power supplied irrespective of the grid availability and non-critical loads 16 loads that allow temporary shut-down of services in case of grid failures. At the emergency electrical bus, which is the point of common coupling (PCC) 18, multiple sources 20, 22 and 24 are connected in parallel and supply the load demand of the CI 12. A first source comprises the grid 20, herein interfaced with a feeder transformer 26 and feeder switch 28, is the main or first, and preferred, power supply in the on-grid mode of the CI 12 feeding both critical load(s) 14 and non-critical load(s) 16. In this exemplary embodiment, two inverters, VSI-1 31 and VSI-2 32 are operating in grid-forming mode and are always synchronized and connected to the PCC 18 by coupling lines 31A and 32A, respectively, irrespective of grid availability. It should be understood at least one VSI would be present, but more than two can also be used. Both VSIs 31, 32 have output voltage and current measurements, while operating with proposed mode-dependent droop controller as described below. Although a single VSI is all that is needed in some applications, in the embodiment illustrated in FIG. 1 two VSIs 31,32 are illustrated. In case of a grid failure, SEPSS needs to ensure that supply to critical load demand is met by VSI-1 31 and VSI-2 32 which are the primary sources of CI in off-grid mode.

Grid availability can be detected using any number of techniques. For instance, standard island detection techniques such as the remote island detection techniques can be used. In one embodiment, supervisory remote island detection can be used because of its fast and accurate performance. Moreover, a non-PLL-based grid re-synchronization process can be used for the grid re-connection process. In yet another embodiment, the status of the feeder switch 28 connecting the CI 12 to the grid 20 can be monitored, or the control signal to the feeder switch 28 can be provided directly or indirectly to the proposed control circuitry. Depending on grid availability, SEPSS will ensure to switch the modes of proposed droop-controller of the VSIs 31, 32 by means of the transmitted status signal 36 referred to as I_{gs} herein I_{gs}=1 in on-grid mode and I_{gs}=0 in off-grid mode, which is represented herein as coming from the feeder switch 28 although as discussed above other techniques can be used. Design objectives of the controller include during normal scenarios where the grid 20 is available, CI 12 is required to be supported only by the grid 20 and both critical load 14 and non-critical load 16 demands need to be met. In case of a grid failure, SEPSS is required to ensure that the CI 12 must meet critical load demands 14 by the local energy resources 22, 24 in off-grid mode.

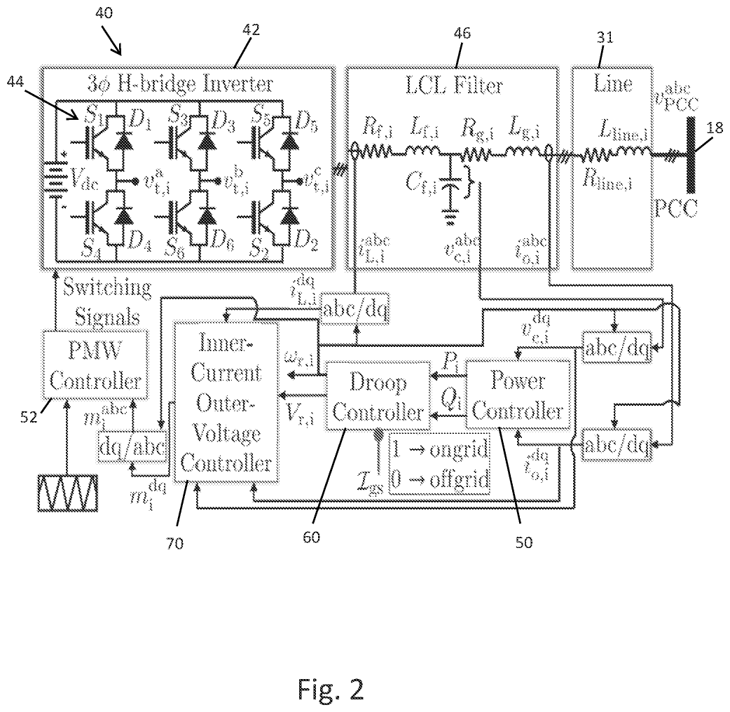

FIG. 2 is a schematic of an exemplary VSI power circuit 40 for VSI 31 or VSI 32. Generally, the power circuit 40 comprises a 3-φ H-bridge 42 having six switches 44 distributed among three legs as shown in FIG. 2. The VSI power circuit 40 is connected to the network at PCC 18 with voltage, v_{PCC}^{abc}, via an LCL filter 46 (L_{f,i}, C_{f,i}, L_{g,i} and associated equivalent series resistances, R_{f,i} and R_{g,i} of inductors) and a coupling line 31 with line parameters, L_{line,i}, R_{line,i}. In this exemplary embodiment, a dq-frame multi-loop controller 50 is employed that generates modulated voltage vector signal, m^{abc}ᵢ to pulse-width modulation (PWM) controller 52 to generate switching signals resulting in terminal voltages, v_{t,i}^{a}, ^{v}t^{b},i and vₜ^{c}_{,i}. The control loop of FIG. 2 is described below.

In controller 50, the dq-axis (w.r.t. i^{th} VSI reference frame) output voltage, vₒ^{dq}ᵢᵢ, and current, i^{dq}_{o,i}, measurements are used to determine the instantaneous active power, pᵢ, and reactive power, qᵢ, of the inverter. (Notation: x^{abc} is defined as [x^{a} x^{b} x^{c}]^{T} and x^{dq} is defined as [x^{d} x^{q}]^{T} where (·)^{T} denotes transposition.) pᵢ and qᵢ are passed through low-pass filters with the time constant, τ_{S,i}∈R_{>0}, to obtain the average active and reactive power as described by

Pᵢ=[1/(τ_{S,i}s+1)]pᵢ,Qᵢ=[1/(τ_{S,i}s+1)]qᵢ, (1)

where pᵢ:=3/2[v_{o,i}^{d}i_{o,i}^{d}+v_{o,i}^{q}i_{o,i}^{p}]
and qᵢ:=3/2 [v_{o,i}^{q}i_{o,i}^{d}−v_{o,i}^{d}i_{o,i}^{q}].

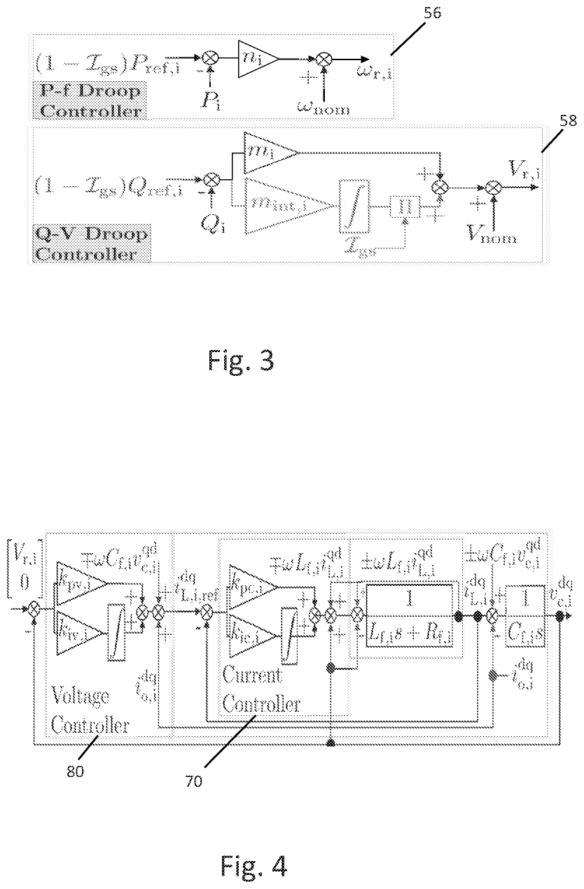

Pᵢ and Qᵢ from controller 50 are provided to droop controller 60, which is a proportional controller with active and reactive power as control variables where the control gain (also the droop gain) dictates the steady-state power sharing of the VSIs. However, in the present invention, a mode-dependent droop controller for each VSI for both on-grid and off-grid operation of the CI is used and illustrated in FIG. 3. The active power, frequency, P-f, droop control 56 is considered here as a proportional controller (with proportional coefficient as nᵢ) with error signal e_{P,i}:=(1−I_{gs})P_{ref,i}−Pᵢ where Pᵢ is the control variable and (1−I_{gs})P_{ref,i} is the reference. Whereas, the reactive power, voltage magnitude, Q-V, droop control 58 is considered here as a proportional-integral controller (with proportional and integral coefficients as mᵢ and m_{int,i} respectively) with error signal e_{Q,i}:=(1−I_{gs})Q_{ref,i}−Qᵢ where Qᵢ is the control variable and (1−I_{gs})Q_{ref,i} is the reference. The additional integral action in Q-V droop is effective only in on-grid mode which is ensured by multiplication of I_{gs} with the integral part. The proposed droop law is as follows:

φ_{r,i}=ωₙₒₘ−nᵢ[Pᵢ−(1−I_{gs})P_{ref,i}], (2)

V_{r,i}=Vₙₒₘ−mᵢ[Qᵢ−(1−I_{gs})Q_{ref,i}]−I_{gs}m_{int,iψi}^{Q}, (3)

ψᵢ^{Q}=∫[Qᵢ−(1− [symbol] _{gs})Q_{ref,i}]dt, (4)

where, ωₙₒₘ, Vₙₒₘ are the nominal frequency (in rad/s) and voltage set-point (in volt) of the system respectively. P_{ref,i} and Q_{ref,i} are the active and reactive power set points, which are commonly set to active and reactive power rating of the i^{th} VSI respectively. The proposed droop control law differs from conventional droop characteristics in the following ways.

Unlike conventional droop control law, an additional integral action, as defined in (4), is introduced in Q-V droop equation. This results in a proportional controller for active power and proportional-integral controller for reactive power with (1−I_{gs})P_{ref,i} and (1−I_{gs})Q_{ref,i} as reference signals respectively.

In addition, Igs, is included in the droop equation that makes the droop law mode dependent (on-grid/off-grid mode). The function of Igs is to modify the droop law based on the transition from on-grid (Igs=1) to off-grid mode (Igs=0). Igs can be detected or based on any number of techniques. For instance, standard island detection techniques such as the remote island detection techniques can be used. In one embodiment, supervisory remote island detection can be used because of its fast and accurate performance. Moreover, a non-PLL-based grid re-synchronization process can be used for the grid re-connection process. In yet another embodiment, the status of the feeder switch 28 connecting the CIs to the grid can be monitored, or the control signal to the feeder switch 28 can be provided directly or indirectly.

The droop controller 60 thus has the following features:
(1) The addition of the integral term, ψᵢ^{Q}, facilitates the VSIs in on-grid mode to supply no reactive power in steady-state; and
(2) The addition of dependency on the variable, Igs, facilitates the VSIs seamless functionality for CIs during the transition of on-/off-grid and off-/ongrid modes.

As indicated above, a supervisory remote island detection algorithm is fast and accurate enough which, by means of any low-bandwidth communication channel, can convey the status, I_{gs}, from SEPSS of CIs to its VSIs, if used. The values of nᵢ and mᵢ are typically chosen such that ω_{r,i} and V_{r,i} are within the allowed specification, defined by IEEE 1547 Standard (“Ieee standard for interconnection and interoperability of distributed energy resources with associated electric power systems interfaces—amendment 1: To provide more flexibility for adoption of abnormal operating performance category iii,” IEEE Std 1547a-2020 (Amendment to IEEE Std 1547-2018), pp. 1-16, 2020), for all Pi∈[0,P_{rated,i}] and Qi∈[−Q_{rated,i}, Q_{rated,i}] respectively. Here, P_{rated,i} and Q_{rated,i} are the rated active and reactive powers that can be delivered by each inverter. Although, these empirical upper bounds of droop co-efficient facilitate the initial design of droop law, system stability-constraint bounds of nᵢ, mᵢ and m_{int,i} require special attention due to the system interconnection and its seamless transition between on-grid and offgrid mode of operation.

In the exemplary embodiment, inner-current-outer-voltage controller architecture is employed for the 3-φ VSIs as illustrated in FIG. 4. For the inner-current controller 70, ^{idq}_{L,i,ref} is provided as the reference signal to be tracked by the output signal, i^{dq}_{L,i}. A proportional-integral (PI) compensator is used for tracking the reference of the dq-axis inductor current. For a desired time constant, τ_{c,i}, the parameters of the current controller 70 are selected as k_{pc,i}=L_{f,i}/τ_{c,i} and k_{ic,i}=R_{f,i}/τ_{c,i}. Depending on the switching frequency, τ_{c,i} is typically selected to be in the range of 0.5-2 ms. Additional feed-forward signals, v_{c}^{dq},ᵢ and ∓ωL_{f,i}i^{qd}_{L,i} facilitate the disturbance rejection capability. For outer-voltage controller 80, [V_{r,i} 0]^{T} is the reference signal to be tracked by the VSI output voltage signal, v_{c}^{dq},ᵢ. A PI compensator 82 is used to enable reference tracking. For a desired phase margin and gain cross-over frequency, the parameters (k_{pv,i} and k_{iv,i}) of the voltage controller 80 can be designed based on symmetrical optimum method. Similarly, additional feed-forward signals, vₒ^{dq},ᵢ and ∓ωC_{f,i}v_{c}^{qd},ᵢ facilitate the disturbance rejection capability for the outer voltage control loop.

To evaluate the performance of the proposed seamless transition method, a controller hardware in the loop based study is conducted. Here a comparison of the always grid-forming strategy presented in this disclosure with the following two methods is presented: Method-1: the seamless transition method of reference by dual-mode control architecture with pre-determined sinusoidal waveform detection and fast commutation current compensation, and Method-2: the seamless transition method of reference where a separate smooth transition compensator is added in the outer-voltage control loop of the grid-forming mode inverter system. The voltage waveform measured at the point of common connection during on-grid to off-grid transition at t≈22 s that results employing grid-forming mode inverters with proposed seamless control, Method-1, and Method-2 respectively. It is observed that the proposed seamless transition method has significantly less transients in the voltage waveform where the existing transition methods, though seamless without any electrical interruptions, has distorted behavior in the waveforms. Similarly, the voltage waveform measured at the point of common connection during off-grid to on-grid transition at t≈42 s that results while employing with proposed seamless control, Method-1, and Method-2 respectively. It is observed that the proposed transition method with modified droop control has better transient behavior compared to the existing methods. Critical loads in a critical infrastructure are usually sensitive to the nature of voltage waveform and therefore the proposed seamless transition method is seemed to be a better fit for EPSS applications.

“Recovery of Power Flow to Critical Infrastructures using Mode-dependent Droop-based Inverters” by Chakraborty, S. S., Patel, S., & Salapaka, M. V. (2021). ArXiv, abs/2102.00046 provides further details of the foregoing. This paper and the references cited therein and US Provisional Patent Application No. 63/441,337, filed Jan. 26, 2023, are all incorporated by reference in their entirety.

The capability, where the grid-forming mode inverter imports power from grid to recharge the battery during on-grid mode after supplying power to the loads in off-grid mode, can be achieved by minor change in the droop laws of as follows:

ω_{r,i}=ωₙₒₘ−nᵢ[Pᵢ−(1−I_{gs})P_{ref,i}+I_{gs}I_{soc}P_{chr,i}],

where, P_{chr,i} is P the power rating at which the i^{th} battery can be recharged. I_{soc} is an indicator that determines whether battery connected to the grid-forming mode inverter needs to be charged or not. I_{soc}=1 signifies that the battery needs charging and I_{soc}=0 signifies that the battery does not need charging. The modification is only in the P-f droop law and the Q-V droop law is same. Strategies for generating I_{soc} can be employed locally or globally and kept for further research, as it is out of scope of the current work.

Although the present invention has been described with reference to preferred embodiments, workers skilled in the art will recognize that changes may be made in form and detail without departing from the spirit and scope of the invention.

What is claimed is:

1. A method of maintaining electrical power to one or more designated loads connected to an electrical bus, the electrical bus being selectively connected to an electric power grid as a first source of power, the electrical bus being connected to an inverter for selectively providing power to the electrical bus from a second source of electrical power, the method comprising:
operating the inverter to be synchronized with the electric power grid and provide a selected amount of active and reactive electrical power from the second source of electrical power while the one or more designated loads receive electrical power from the electric power grid;
monitoring connection of the electrical bus to the electric power grid; and
at the time the electrical bus is no longer receiving power from the electrical grid, operating the inverter to provide required power without interruption to the one or more designated loads of the electrical bus.

2. The method of claim 1 wherein the selected amount of active and reactive power is zero.

3. The method of claim 1 wherein monitoring connection of the electrical bus to the electrical power grid comprises island detection.

4. The method of claim 1 wherein monitoring connection of the electrical bus to the electrical power grid comprises monitoring status or operation of the connection of the electrical bus to the electric power grid.

5. The method of claim 4 wherein a feeder switch selectively electrically connects the electrical bus to the electric power grid, and wherein monitoring status or operation of the connection of the electrical bus to the electric power grid comprises monitoring the status or operation of the feeder switch.

6. The method claim 5 wherein the electrical bus is connected to a second inverter for selectively providing power to the electrical bus from a third source of electrical power, the method further comprising:
operating the second inverter to be synchronized with the electric power grid and provide a second selected amount of active and reactive electrical power from the third source of electrical power while the one or more designated loads receive electrical power from the electric power grid; and
wherein at the time the electrical bus is no longer receiving power from the electrical grid, operating each of the inverter with the second inverter so that each provides electrical power and together the inverter and the second inverter provide the required power without interruption to the one or more designated loads of the electrical bus.

7. The method of claim 6 wherein the selected amount of active and reactive power is zero.

8. The method claim 1 wherein the electrical bus is connected to a second inverter for selectively providing power to the electrical bus from a third source of electrical power, the method further comprising:
operating the second inverter to be synchronized with the electric power grid and provide a second selected amount of active and reactive electrical power from the third source of electrical power while the one or more designated loads receive electrical power from the electric power grid; and
wherein at the time the electrical bus is no longer receiving power from the electrical grid, operating each of the inverter with the second inverter so that each provides electrical power and together the inverter and the second inverter provide the required power without interruption to the one or more designated loads of the electrical bus.

9. A system for maintaining electrical power to one or more designated loads connected to an electrical bus, the electrical bus being selectively connected to an electric power grid as a first source of power, the system comprising:
a second source of electrical power;
an inverter connected to the second source of electrical; and
a controller receiving an input indicating if the electrical bus is connected to the electrical power grid, the controller being configured to:
selectively provide a selected amount of active and reactive electrical power to the electrical bus from the second source of electrical power while being synchronized with the electric power grid and while the one or more designated loads receive electrical power from the electric power grid;
based on the input, monitor the connection of the electrical bus to the electric power grid; and
at the time the electrical bus is no longer receiving power from the electrical grid, operate the inverter to provide required power without interruption to the one or more designated loads of the electrical bus.

10. The system of claim 9 wherein the second selected amount of active and reactive power is zero.

11. The system of claim 10 wherein the input is based on island detection.

12. The system of claim 10 wherein the input comprises a status or operation of the connection of the electrical bus to the electric power grid.

13. The system of claim 12 wherein a feeder switch selectively electrically connects the electrical bus to the electric power grid, and wherein the input comprises the status or operation of the feeder switch.

14. The system of claim 13 and further comprising:
a third source of electrical power;
a second inverter connected to the third source of electrical power;
configured to selectively provide a selected amount of power to the electrical bus from the third source of electrical power while being synchronized with the electric power grid and while the one or more designated loads receive electrical power from the electric power grid; and
wherein the controller is configured to:
selectively provide a second selected amount of active and reactive electrical power to the electrical bus from the second source of electrical power while being synchronized with the electric power grid and while the one or more designated loads receive electrical power from the electric power grid; and
at the time the electrical bus is no longer receiving power from the electrical grid, operate each of the inverter with the second inverter so that each provides electrical power and together the inverter and the second inverter provide the required power without interruption to the one or more designated loads of the electrical bus.

15. The system of claim 14 wherein the second selected amount of active and reactive power is zero.

16. The system of claim 9 and further comprising:
a third source of electrical power;
a second inverter connected to the third source of electrical power;
configured to selectively provide a selected amount of power to the electrical bus from the third source of electrical power while being synchronized with the electric power grid and while the one or more designated loads receive electrical power from the electric power grid; and
wherein the controller is configured to:
selectively provide a second selected amount of active and reactive electrical power to the electrical bus from the second source of electrical power while being synchronized with the electric power grid and while the one or more designated loads receive electrical power from the electric power grid; and
at the time the electrical bus is no longer receiving power from the electrical grid, operate each of the inverter with the second inverter so that each provides electrical power and together the inverter and the second inverter provide the required power without interruption to the one or more designated loads of the electrical bus.

17. The system of claim 16 wherein the second selected amount of active and reactive power is zero.

18. An apparatus configured to maintain electrical power to one or more designated loads connected to an electrical bus, the electrical bus being selectively connected to an electric power grid as a first source of power, the apparatus comprising:
an inverter configured to be connected to a second source of electrical; and
a controller connected to the inverter and receiving an input indicating if the electrical bus is connected to the electrical power grid, the controller being configured to:
selectively control the inverter to provide a selected amount of active and reactive electrical power to the electrical bus from the second source of electrical power while being synchronized with the electric power grid and while the one or more designated loads receive electrical power from the electric power grid;
based on the input, monitor the connection of the electrical bus to the electric power grid; and
at the time the electrical bus is no longer receiving power from the electrical grid, operate the inverter to provide required power without interruption to the one or more designated loads of the electrical bus.

19. The apparatus of claim 18 wherein the second selected amount of active and reactive power is zero.

20. The apparatus of claim 18 wherein the input is based on island detection or comprises a status or operation of the connection of the electrical bus to the electric power grid.
